(19) United States
(12) Patent Application Publication
(10) Pub. No.: US 2010/0294375 A1
(43) Pub. Date: Nov. 25, 2010

(54) SPEED CONTROL VALVE SYSTEM

(75) Inventor: Allan Bo ANDERSSON, Cambridge, NY (US)

Correspondence Address: HESLIN ROTHENBERG FARLEY & MESITI PC, 5 COLUMBIA CIRCLE, ALBANY, NY, 12203, US

(73) Assignee: DANFOSS FLOMATIC CORPORATION, Glens Falls, NY (US)

(21) Appl. No.: 12/470,194

(22) Filed: May 21, 2009

(51) Int. Cl. F16K 31/12

(52) U.S. Cl. 137/12; 137/485; 137/505

(57) ABSTRACT

A speed controller valve system for regulating an opening speed and a closing speed of a pressure reducing valve includes a first inlet couplable to a main valve inlet of a pressure reducing valve. An outlet is couplable to a power chamber of the pressure reducing valve to control a flow of fluid between the outlet and the power chamber to control an opening and/or a closing of the pressure reducing valve. An interior chamber connects the first inlet and the outlet. The chamber receives a resilient member connected to a tapered valve poppet received in the first inlet and moveable in response to a flow of fluid at a pre-set pressure from the main valve inlet to the first inlet. The poppet is located in the chamber and the resilient member includes a resiliency to regulate an amount of movement of the poppet at the pre-set pressure to regulate a flow between the first inlet and the power chamber of the pressure reducing valve.

### BACKGROUND OF THE INVENTION

1. Technical Field

The present invention generally relates to pressure reducing valves. More particularly, the present invention relates to a speed controller valve for controlling the opening and closing speeds of a pressure reducing valve.

2. Background Information

Pressure reducing valves ensure practical, safe working water pressures. Municipal and private water suppliers use pumps and pumping stations to boost water supply pressures in supply mains to supply water for, for example, fire fighting, high rise buildings to overcome loss of pressure as elevation increases, and to maintain water supply in water towers and supply tanks.

Pressure in water supply mains can exceed two hundred pounds per square inch, while most plumbing codes require water pressure reducing valves on domestic systems where the municipal water main's pressure exceeds eighty pounds per square inch. Higher pressure could potentially rupture pipes, damage fixtures and even result in injury to the people using them. The regulation of pressure from water supplies is also critical in, for example, a distribution system, a constant operating pressure in an industrial process and nozzles of an irrigation system.

A pressure reducing valve installed after (i.e., downstream of) a water meter in homes, commercial buildings and manufacturing plants is often utilized to automatically reduces the pressure from the water supply main to a lower, more constant and useful pressure. In operation, water entering such a pressure reducing valve from, for example, municipal mains is constricted within a valve body and directed through an inner chamber controlled by a spring-loaded diaphragm or disc. The spring holds a pre-set tension, usually pre-set by the factory, on a valve seat installed with a pressure equalizing mechanism for controlling water pressure. Even if the supply water pressure fluctuates, the pressure-reducing valve ensures a constant pressure at varying flow of water at a constant pressure, as long as the supply pressure does not drop below the valve's pre-set pressure.

A speed controller valve may be used as a pilot valve to regulate the flow of water in and out of a main valve top chamber of a main pressure reducing valve. An inlet portion of the speed controller valve is connected through a pilot control tubing to an inlet side of the main pressure reducing valve, which is the up-stream side of the main valve where the pressure is higher and unregulated. In addition, the inlet side may also be connected to the outlet side of the main control valve through pilot control tubing, which is the downstream side of the main control valve where the water pressure is lower and regulated. The outlet side of the speed controller valve is connected to the top power chamber of the main control valve, which allows the speed controller valve to control the flow of water in and out the top power chamber of the control valve. Therefore, the main control valve opening and closing speed can be controlled and regulated through the use of a speed controller valve. The pressure regulating sensitivity and lack thereof of the main control valve is dependant on the function of the speed controller valve.

A conventional speed controller valve used with a pressure regulating valve has a valve chamber defining a valve seat. On one side of the valve chamber is an opening through which primary pressure is introduced and on another side thereof is another opening communicating with a secondary side of the pressure regulating valve. Conventional speed controller valves may also have a flat valve disk with a seating surface disposed within the valve chamber. The flat valve disk is guided on a needle valve stem supported by the speed controller valve. The valve disk receives pressure on a first surface from the primary pressure source in a valve opening direction and pressure on a second surface from the primary pressure source in a flat valve closing direction. The first and second surfaces of the flat valve disk have substantially the same shape and size. The valve disk may be biased against the valve seat of the valve chamber by a spring.

Thus, a need exists for a pressure reducing valve system including a speed controller valve which efficiently controls a flow into and out of the speed controller valve to control an opening and closing speed of a pressure reducing valve.

### SUMMARY OF THE INVENTION

The present invention provides, in a first aspect, a speed controller valve system for regulating an opening speed and a closing speed of a pilot operated control valve, such as a pressure reducing valve, which includes a first inlet couplable to a main valve inlet of a pilot operated control valve. An outlet is couplable to a power chamber of the pilot operated control valve to control a flow of fluid between the outlet and the power chamber to control an opening and/or a closing of the pressure reducing valve. An interior chamber connects the first inlet and the outlet. The chamber receives a resilient member connected to a tapered valve poppet received in the first inlet and moveable in response to a flow of fluid at a pre-set pressure from the main valve inlet to the first inlet. The poppet is located in the chamber and the resilient member includes a resiliency to regulate an amount of movement of the poppet at the pre-set pressure to regulate a flow between the first inlet and the power chamber of the pressure reducing valve.

The present invention provides, in a second aspect, a pressure reducing system including a pressure reducing valve and a speed controller valve. The pressure reducing valve includes a main valve inlet, a main valve outlet, and a power chamber. The speed controller valve includes a first inlet in fluid communication with the main valve inlet. The speed controller valve includes a first outlet in fluid communication with the power chamber to control a fluid between the outlet and the power chamber to control and opening and/or a closing of the pressure reducing valve. An interior chamber connects the first inlet and the first outlet. The chamber receives a resilient member connected to a tapered valve poppet. The poppet is received in the first inlet and is moveable in response to a flow of fluid at a pre-set pressure from the main valve inlet to the first inlet. The poppet is located in the chamber and the resilient member has a resiliency to regulate an amount of movement of the poppet axially relative to the chamber at the pre-set pressure to regulate a flow between the first inlet and the power chamber of the pressure reducing valve.

The present invention provides, in a third aspect, a method for regulating an opening and a closing of a pressure reducing valve which includes coupling a first inlet of a speed controller valve to a main valve inlet of the pressure reducing valve. An outlet of the speed reducing valve is coupled to a power chamber of the pressure reducing valve. A tapered valve poppet is connected to an interior surface of an interior chamber of the speed controller via a resilient member. The poppet and the resilient member are adjusted such that a pre-set pressure in the first inlet moves the poppet toward the chamber to regulate a flow of fluid past the poppet to the outlet to the power chamber to regulate an opening and/or a closing of the pressure reducing valve.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention will be apparent from the following detailed description of preferred embodiments taken in conjunction with the accompanying drawings in which:

FIG. 1 depicts a block diagram view of a pressure reducing valve system in accordance with the present invention;

FIG. 2 depicts a side elevational view of the speed controller valve of FIG. 1;

FIG. 3 depicts a side cross-sectional view of the speed controller valve of FIG. 1;

FIG. 4 depicts a side elevational view of a poppet of the speed controller valve of FIG. 1;

FIG. 5 depicts a top elevational view of the poppet of FIG. 4;

FIG. 6 depicts a side elevational view of the poppet of FIGS. 4-5 and the valve stem and poppet stop of FIG. 3;

FIG. 7 depicts a side cross-sectional view of the speed controller valve of FIG. 2 showing the poppet in an open position; and

FIG. 8 depicts a side cross-sectional view of the speed controller valve of FIG. 7 showing the poppet in a closed position.

### DETAILED DESCRIPTION OF THE INVENTION

In accordance with the principles of the present invention, a speed controller valve, a pressure reducing valve and methods for controlling a pilot operated control valve, such as for controlling water pressure, are provided.

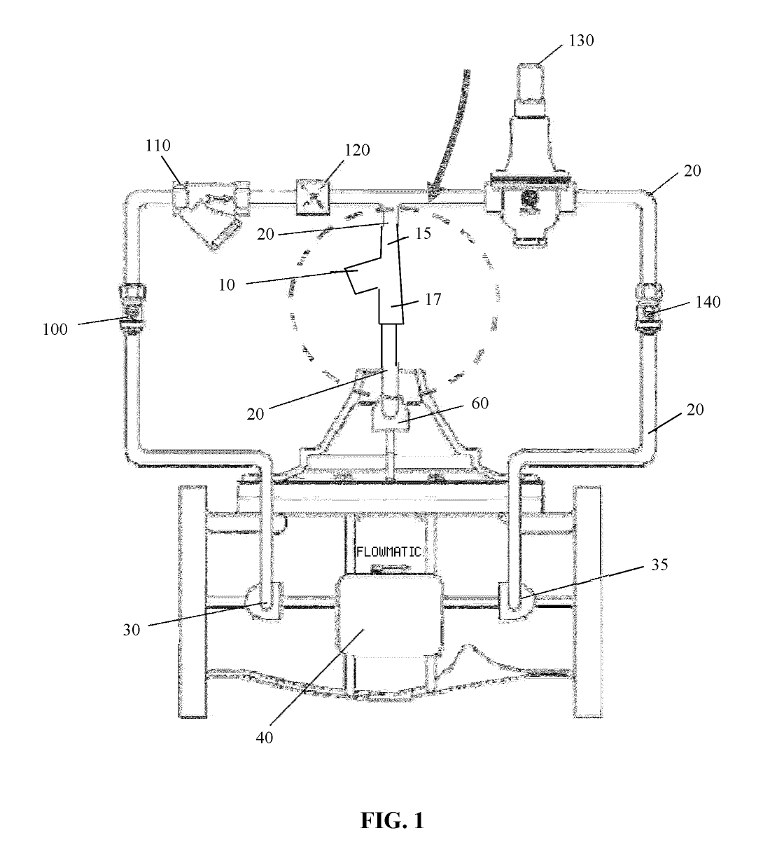

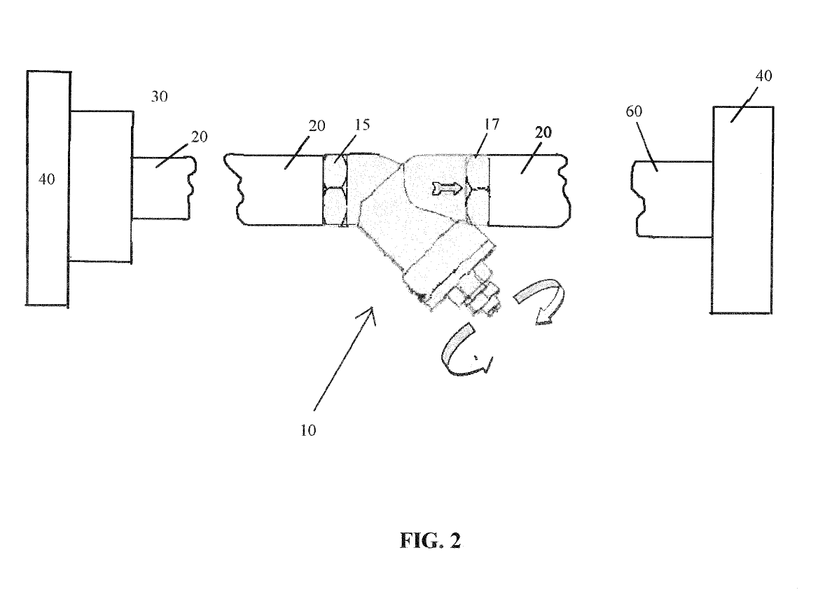

FIG. 1 depicts a speed controller valve 10 having an inlet 15 connected via a pilot control tubing 20 to an inlet side 30 of a main pressure reducing valve 40. Inlet side 30 is an upstream side of main pressure reducing valve 40 where the pressure is higher and unregulated relative to a downstream side. For example, inlet side 30 may be connected to a water supply source, such as a public water supply main.

In addition, inlet 15 may also be connected to an outlet side 35 of main control valve 40 by pilot control tubing 20. Outlet side 35 is a downstream side of main control valve 40 where the water pressure is lower (i.e., relative to inlet side 30) and has been regulated by the main pressure reducing control valve itself. For example, water in a water supply main pipeline may exceed 200 PSI while many plumbing codes require water pressure reducing valves when water pressure exceeds 80 PSI. Thus, such a water pressure reducing valve (e.g., pressure reducing valve 40) may reduce such water pressure from 200 PSI to less than 80 PSI.

An outlet 17 of speed controller valve 10 is connected to a top power chamber 60 of main pressure reducing valve 40. The speed controller valve controls the flow of water into and out of top power chamber 60 of the control valve. The water pressure in tubing 20 between outlet 17 and top power chamber 60 (and/or a flow of water between outlet 17 and top power chamber 60) regulates the opening and closing speed of main pressure reducing valve 40.

As depicted in FIG. 1, an isolation valve 100, a y-strainer 110, and an orifice valve 120 may be present between speed controller valve 10 (i.e., inlet 15) and inlet side 30 connected by tubing 20 while a pressure regulating pilot valve 130 and an isolation valve 140 may be present between speed controller valve 10 (i.e., inlet 15) and outlet side 35 connected by tubing 20.

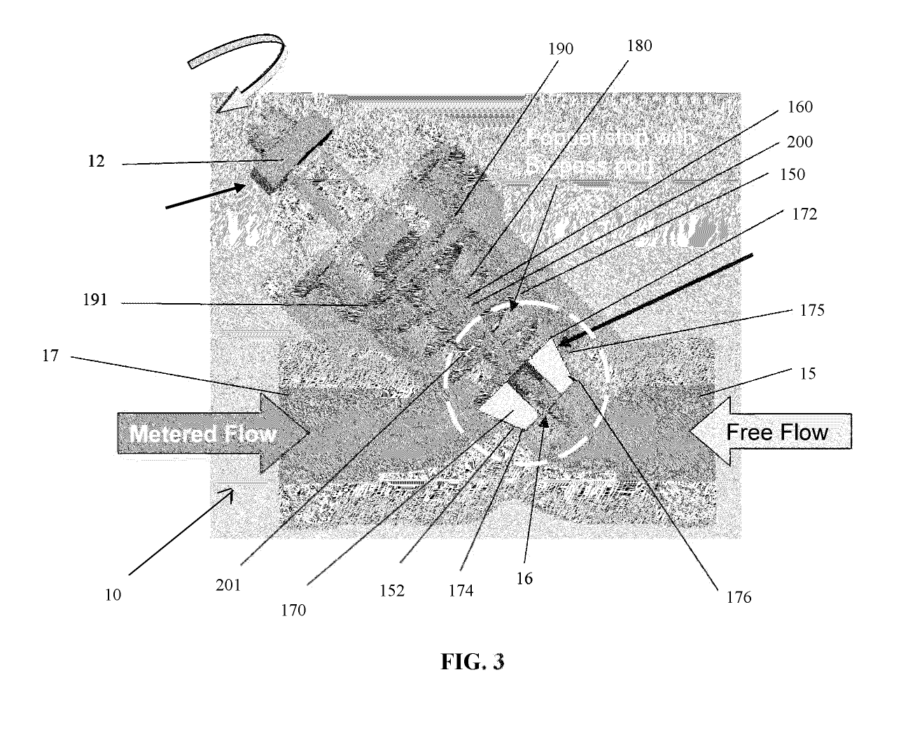

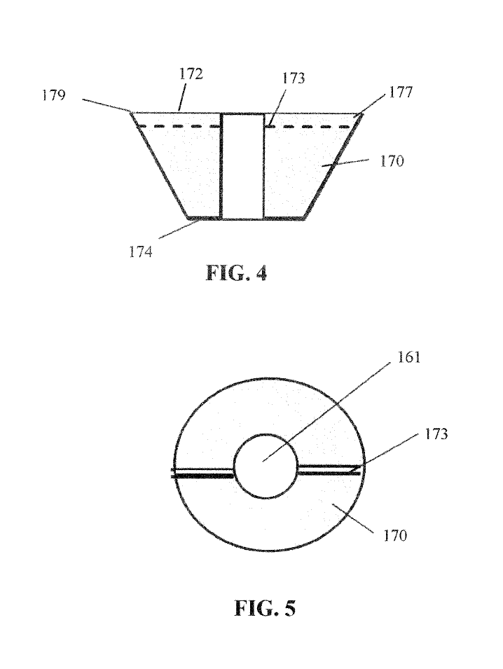

As depicted in FIG. 3, speed controller valve 10 includes an interior chamber 150 between inlet 15 and outlet 17. Speed controller valve 10 may be a needle valve. More specifically, a needle valve stem 160 is received in, and axially aligned with a longitudinal axis of, chamber 150. A valve poppet 170 is located at a first end 175 of chamber 150 and a resilient member, such as a spring 180, is connected to poppet 170 and a top interior surface 190 bounding a top end 191 of chamber 150. Needle valve stem 160 is received in a needle stem cavity 161 (FIG. 5) of poppet 170, and poppet 170 and stem 160 in cavity 161 may be movable relative to each other. Poppet 170 may have a modified cone shape (e.g., frusto-conical) such that a top end 172 closer to chamber 150 has a larger diameter than a bottom end 174. The cone shape allows an incremental adjustment in (e.g., a throttling of) a distance between outer surface 176 of poppet 170 and an interior surface 152 of inlet 15 by moving along the longitudinal axis of chamber 150 into or out of inlet 15. Such movement of poppet 170 adjusts a size of a passage between outer surface 176 and interior surface 172 from inlet 15 to chamber 150 thereby regulating an amount of flow from inlet 15 through chamber 150 to outlet 17 and therefore to top power chamber 160 of pressure reducing valve 40.

Also, as depicted in FIGS. 4-5, for example, poppet 170 has an axial thickness of an amount which allows the incremental adjustment as poppet 170 is selectively moved into and out of inlet 15. Further, the thickness (eg., 0.25 in.) of the poppet axially allows for more stability of the poppet as the poppet moves along valve stem 160 as compared to a flatter disc design in prior art poppets. In particular, the axial distance of needle stem cavity 161 bounded by an interior surface 162 provides for stability of the poppet in response to any force in a non-axial direction relative to chamber 150 and poppet 170. In particular, the increased axial distance of coupling of needle stem 160 with poppet 170 provides for increased contact of needle stem 160 and interior surface 162 in the event of force in a non-axial direction relative to poppet 170. Such increased contact inhibits excessive movement in a non-axial direction relative to poppet 170 and thereby maintains poppet 170 in a desired position.

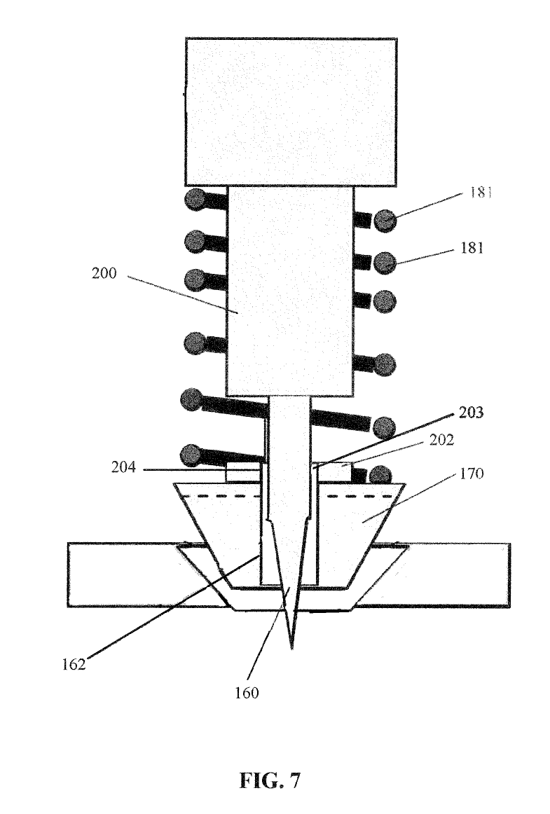

A resilient member (e.g., spring 180) may hold poppet 170 at a desired position and may provide resistance to a flow of water through inlet 15 past poppet 170 to chamber 150 up to a particular preset pressure as depicted in FIGS. 3 and 7. Such a particular preset pressure may be preset by adjustment of an adjustment mechanism (e.g., an adjustment nut 12) connected to spring 180 and valve stem 160, e.g., by a rotation of the adjustment mechanism. The adjustment mechanism may include a threaded shaft connected to interior surface 190. For example, a rotation of adjustment nut 12 may cause interior surface 190 to move toward inlet 15 thereby moving spring 180 and poppet 170 attached thereto in the same direction thereby controlling the opening and closing of the pressure reducing valve and/or providing more or less pressure sensitivity to the opening and/or closing of the pressure reducing valve.

Poppet 170 may thus be inserted into inlet 15 by movement of such adjustment mechanism thereby inhibiting water flow from inlet 15 toward chamber 150 past poppet 170 between outer surface 176 and interior surface 152. Alternatively, poppet 170 may be located relative to (e.g., spaced from) inlet 15 to allow water to flow into chamber 150. Further, poppet 170 may be located and the resilient member (e.g., spring 180) may be configured (e.g., be shaped and have a particular resiliency) to allow flow into chamber 150 based on a particular desired preset water pressure in inlet 150 pressing on poppet 170. For example, when water pressure in inlet 15 coupled to inlet side 30 and/or outlet side 35 exceeds a particular preset pressure set by a location of poppet 170 and spring 180, along with the resiliency of spring 180, the spring may allow for movement of poppet 170 along stem 160 to increase a flow passage between outer surface 176 of poppet 170 and an interior surface 152 of inlet 15 thereby allowing more flow through chamber 150 to outlet 17 and therefore top power chamber 60. Such an increase in flow to top power chamber 60 may cause increased closing speed of main pressure reducing valve 40 thereby inhibiting flow from an upstream source, such as a city or public water main, past the pressure reducing valve thereby decreasing pressure downstream of the pressure reducing valve. Accordingly, an opening speed and/or closing speed of pressure reducing valve 40 may be controlled by the location of poppet 170 and the resiliency of a resilient member (e.g., spring 180) holding the poppet in chamber 180 and/or inlet 15.

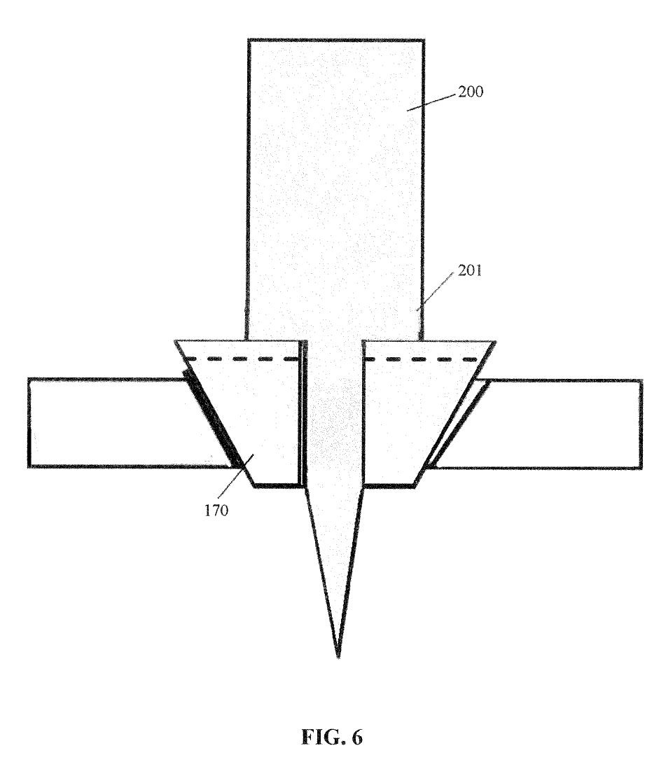

A poppet stop 200 may be axially aligned with, and surround, needle stem 160 and may be attached to top interior surface 190 of chamber 150 as depicted in FIGS. 3 and 6. Poppet stop 200 may be cylindrical in shape and may have an axial length which provides a maximum desired opening of poppet 170 and therefore a maximum flow passage from inlet 15 through chamber 150 to outlet 17. In particular, poppet 170 may move toward top end 190 and against spring 180 in response to a particular water pressure in inlet 15 which is above a desired pressure preset by an adjustment mechanism such that the pressure is above that at which spring 180 is configured to hold the poppet at a desired position. A movement of poppet 170 in such axial direction against spring 180 may be stopped by a contact of a bottom end 201 of poppet stop 200 with poppet 170. Poppet stop 200 may be axially adjustable with top interior surface 190, spring 180, and poppet 170 via an adjustment mechanism, such as adjustment nut 12 and needle valve stem 160.

Poppet 170 may also include a bypass port 210 located on top end 172 thereof as depicted in FIGS. 4-5. Bypass port 210 may be a groove formed in top end 172 which extends from a first side 177 of top end 172 to a second side 179 thereof. For example, port 210 may extend a diameter of top end 172 via two grooves extending radially from opposite outside edges to needle stem cavity 161 receiving needle stem 160 at the center of poppet 170. Port 210 may provide fluid communication between such opposite radial sides of the poppet and needle stem cavity 161 when poppet 170 is fully received in inlet 15 such that the inlet is closed (i.e., inhibiting the flow of the fluid past the poppet between outer surface 176 and interior surface 152) relative to chamber 150 as depicted in FIG. 6. Port 210 may be bounded by a bottom side 201 of poppet stop 200 and a groove surface 173 of top end 172 of top 170 when poppet stop 200 contacts poppet 170. Port 210 therefore allows limited flow from chamber 150 past poppet 170 through port 210 and needle stem cavity 161 to inlet 15 or vice versa when poppet is fully received in inlet 15 and poppet stop 200 contacts poppet 170. Bypass port 210 provides a pressure release function when poppet is fully received in inlet 15 such that any passage between outer surface 176 of poppet 170 and interior surface 152 of inlet 15 is closed. For example, water may flow from chamber 150 past poppet 170 through port 210 and needle stem cavity 161 to inlet 15 thereby inhibiting any damage which may otherwise be caused by excessive pressure in pilot control tubing 20 between inlet 15 and inlet side 30/or inlet side 35. Further, the flow through needle valve stem cavity 161 may be constant regardless of a location of poppet 170 between first end 175 of chamber 150 and bottom end 201 of poppet stop 200. For example, a resiliency of spring 180 may provide that the flow through cavity 161 remains constant despite a movement of poppet 170.

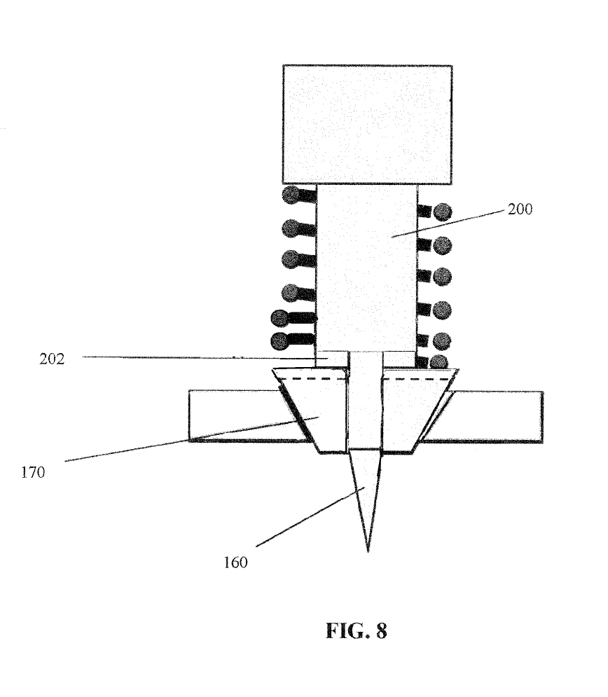

In another example, depicted in FIGS. 7-8, poppet 170 is connected to spring 180 such that spring 180 does not coil-up (i.e., cause the coils of spring 180 to be stacked on one another) in response to movement of needle valve stem 160 and poppet stop 200 toward poppet 170 as poppet 170 is fully received in inlet 15 (FIG. 8) such that any passage between outer surface 176 of poppet 170 and interior surface 152 of inlet 15 is closed. A poppet stop bushing 202 extends axially within spring 180 from poppet 170 toward poppet stop 200 as depicted in FIG. 7 showing the valve open (i.e., poppet 170 not entirely received in inlet 15 and allowing flow from inlet 15 around the outside surface (i.e., between outer surface 176 and interior surface 152) of poppet 170 to interior 150) and poppet stop bushing 202 spaced from poppet stop 200. FIG. 8 shows the poppet received in inlet 15 closing the inlet (i.e., inhibiting flow between outer surface 176 and interior surface 152) relative to chamber 150 and poppet stop bushing 202 contacting poppet stop 200. Individual coils 181 of spring 180 avoid contacting each other in both the open position depicted in FIG. 7 and the closed position depicted in FIG. 8. For example, the contacting of poppet stop bushing 202 and poppet stop 200 prevents movement of needle valve stem 160 and spring axially past a point after which coils 181 would contact each other. Poppet stop bushing 202 and poppet stop 200 may have about a same outside diameter such that the outside diameters present a substantially uniform (e.g., cylindrical) surface in the closed position. By maintaining a space between each of coils 181 unstable operation and premature wear of the spring (i.e., spring 180) may be avoided. In particular, when such coils contact one another friction may cause them to wear on one another thereby causing damage to the coils. Further, the spacing between coils 181 as depicted in FIGS. 7-8 prevents the entangling or otherwise attaching of such coils to each other which may inhibit an extension force due to the resiliency of spring 180. Further, poppet stop bushing 202 may promote a centering of poppet 170 on needle valve stem 160. For example, as depicted in FIG. 7, poppet stop bushing 202 has a cavity 203 having about a same diameter as needle stem cavity 161 of poppet 170. Thus, an inside surface 204 of poppet stop 202 extends axially relative to needle valve stem 160 such that the inside surface would maintain needle valve stem 160 centered between such inside surfaces in cavity 203 and cavity 161 if needle valve stem 160 contacts such inside surfaces.

As described above, an adjustment mechanism (e.g., adjustment nut 12 and needle valve stem 160) in combination with a spring, such as spring 180, and poppet 170 may regulate a flow from inlet 15 through chamber 150 to outlet 17 based on a fluid pressure present in inlet 15. Such flow may regulate an opening and closing of main control valve 40 and pilot valve 130 based on a flow thereto (e.g., to top power chamber 60). Further, a flow from the pressure reducer (e.g., top power chamber 60) to outlet 17 and inlet 15 through chamber 50 may be regulated by the adjustment mechanism and thus the extent to which poppet 170 extends into inlet 15 and therefore the size of the passage between outer surface 176 of poppet 170 and interior surface 152 of inlet 15. As described above, the tapered nature of poppet 170 allows an incremental opening and closing (i.e., throttling) of valve 10 therefore allowing an incremental increase or decrease in the passage past poppet 170 (i.e., between outer surface 176 and interior surface 152) to inlet 15, or to outlet 17, depending on a direction of fluid flow. For example, as poppet 170 extends into inlet 15, the flow past poppet 170 (i.e., between outer surface 176 and interior surface 152) decreases until flow around the outside of the poppet substantially stops. In contrast, as the poppet is removed from inlet 15, e.g., by a rotation of the adjustment mechanism (e.g., adjustment nut 12 and needle valve stem 160) the flow past the poppet (i.e., between outer surface 176 and interior surface 152) increases to a maximum flow when the poppet is completely outside inlet 15.

Speed controller valve 10 including components thereof (e.g., poppet 170, spring 180, and needle valve stem 160) may be configured to withstand the pressures (e.g., from 200 psi to less than 80 psi) which would be applied thereto by a flow received from a public water supply main without failure. For example, controller valve 10 and/or some components thereof may be formed of metal (e.g., stainless steel) or thermoplastic. Further, spring 180 may be connected to interior surface 190 and/or top end 172 of poppet 170 in any number of ways which allows spring 180 to be fixed thereto while allowing spring 180 to move (e.g., compress) axially toward poppet 170 while coils 181 thereof move toward one another, preferably without the coils touching each other.

The adjustment mechanism (e.g., adjustment nut 12 and needle valve stem 160) described above could be any mechanism for advancing and retreating poppet stop 200, spring 180 and poppet 170 relative to inlet 15. Also, the poppet stop (e.g., poppet stop 200), described above, could be any shape or size which stops movement of the poppet (e.g., poppet 170), at a particular position when a pressure force on the poppet (e.g., in inlet 15) exceeds that which would allow a resilient member, such as a spring 180, to stop movement of the poppet.

Further, as described above, inlet 15 of speed controller valve 10 may be in fluid communication with an inlet (e.g., inlet side 30) and/or an outlet (e.g., outlet side 35) of a pressure reducer valve such that the water flow pressures at such inlet and outlet may regulate an opening and closing speed of such pressure reducer regulated by a speed controller valve, such as speed controller valve 10.

Also, it would be understood by one skilled in the art that although a speed controller valve system is described relative to a pressure reducing valve above, the speed controller valve system described could be utilized with other pilot operated control valves or like valves.

While several aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

1. A speed controller valve system for regulating an opening speed and a closing speed of a pilot operated control valve,the speed controller valve system comprising:
a first inlet couplable to a main valve inlet of a pilot operated control valve;
an outlet couplable to a power chamber of the pilot operated control valve to control a flow of fluid between said outlet and the power chamber to control at least one of an opening and a closing of the pressure reducing valve;
an interior chamber connecting said first inlet and said outlet, said chamber receiving a resilient member connected to a tapered valve poppet, said poppet received in said first inlet and movable in response to a flow of fluid at a preset pressure from the main valve inlet to said first inlet, said poppet located in said chamber and said resilient member having a resiliency to regulate an amount of movement of said poppet at said preset pressure to regulate a flow between said first inlet and the power chamber of the pressure reducing valve.

2. The system of claim 1 wherein said poppet comprises a larger diameter proximal to said chamber and a lesser diameter distal to said chamber.

3. The system of claim 1 wherein said poppet comprises a cone shape.

4. The system of claim 1 wherein a flow passage between an outer surface of said poppet and an interior surface of said first inlet increases in response to said poppet moving toward an interior of said chamber, said space allowing a flow of fluid past said poppet.

5. The system of claim 1 wherein said chamber and said first inlet are axially aligned, said chamber and said first inlet having different diameters relative to each other.

6. The system of claim 1 further comprising a poppet stop configured to stop said poppet from moving past said stop toward an opposite end of said chamber relative to said inlet.

7. The system of claim 6 wherein said poppet comprises a stop member extending axially toward said poppet stop such that coils of said resilient member are spaced from each other when said poppet stop contacts said stop member.

8. The system of claim 1 wherein said poppet further comprises a groove on a top side of said poppet in fluid communication with a stem cavity of said poppet to allow a flow of fluid past said poppet when said poppet contacts said stop and said poppet is received in said first inlet such that the a flow of fluid past an outer surface of said poppet is avoided.

9. The system of claim 1 wherein said poppet receives a needle valve stem in a central cavity of said poppet.

10. The system of claim 1 wherein said first inlet is couplable to a main valve outlet of the pressure reducing valve.

11. A pressure reducing system comprising:
a pressure reducing valve having a main valve inlet, a main valve outlet, and a power chamber; and
a speed controller valve comprising:
a first inlet in fluid communication with the main valve inlet;
a first outlet in fluid communication with said power chamber to control a flow of fluid between said outlet and said power chamber to control at least one of an opening and a closing of said pressure reducing valve;
an interior chamber connecting said first inlet and said first outlet, said chamber receiving a resilient member connected to a tapered valve poppet, said poppet received in said first inlet and moveable in response to a flow of fluid at a preset pressure from the main valve inlet to said first inlet, said poppet located in said chamber and said resilient member having a resiliency to regulate an amount of movement of said poppet axially relative to said chamber at said preset pressure to regulate a flow between said first inlet and said power chamber of said pressure reducing valve.

12. The system of claim 11 wherein said poppet comprises a cone shape having a larger diameter proximal to said chamber and a lesser diameter distal to said chamber.

13. The system of claim 11 wherein a flow passage between an outer surface of said poppet and an interior surface of said first inlet increases in response to said poppet moving toward an interior of said chamber, said flow passage allowing a flow of fluid past said poppet.

14. The system of claim 11 further comprising a poppet stop configured to stop said poppet from moving past said stop toward an opposite end of said chamber relative to said inlet.

15. The system of claim 11 wherein said poppet further comprises a groove on a top side of said poppet in fluid communication with a stem cavity of said poppet to allow a flow of fluid past said poppet when said poppet contacts said stop and said poppet is received in said first inlet such that a flow of fluid past an outside surface of said poppet is avoided.

16. A method for regulating an opening and a closing of a pressure reducing valve comprising:
coupling a first inlet of a speed controller valve to a main valve inlet of the pressure reducing valve;
coupling an outlet of the speed reducing valve to a power chamber of the pressure reducing valve;
connecting a tapered valve poppet to an interior surface of an interior chamber of the speed controller valve via a resilient member;
adjusting the poppet and the resilient member such that a preset pressure in the first inlet moves the poppet toward the chamber to regulate a flow of fluid past the poppet to the outlet to the power chamber to regulate at least one of an opening of the pressure reducing valve and a closing of the pressure reducing valve.

17. The method of claim 16 further comprising closing the speed controller valve by locating the poppet in the inlet to inhibit flow from the first inlet past an outer surface of the poppet to the outlet to the power chamber.

18. The method of claim 17 further comprising flowing fluid from the first inlet through an interior valve stem cavity of the poppet to a groove on a side of the poppet to the chamber to the outlet to the power chamber.

19. The method of claim 16 further comprising moving the resilient member and the poppet toward the inlet to regulate the preset pressure that moves the poppet to allow a flow past the poppet to the chamber to the outlet.

20. The system of claim 1 wherein said pilot operated control valve comprises a pressure reducing valve.
